(19) United States
(12) Patent Application Publication
(10) Pub. No.: US 2021/0246615 A1
(43) Pub. Date: Aug. 12, 2021

(54) MACHINE-TOOL SYSTEM, PARTICULARLY FOR WORK ON A RAILWAY LINE

(71) Applicant: GEISMAR, Neuilly Sur Seine (FR)

(72) Inventors: Olivier GASPARD, Saint Ondras (FR); Olivier THUBERT, Domène (FR); Quentin TAVERGNIER, Lyon (FR)

(21) Appl. No.: 17/255,102

(22) PCT Filed: Jun. 21, 2019
(86) PCT No.: PCT/FR2019/051530

§ 371 Date: Dec. 22, 2020

(30) Foreign Application Priority Data
Jun. 22, 2018 (FR) 18 55 597

(51) Int. Cl. E01B 31/04; B23D 45/04; B23D 45/00; B25F 5/00

(52) U.S. Cl. CPC E01B 31/04; B25F 5/006; B23D 45/003; B23D 45/046

(57) ABSTRACT

A machine-tool system, particularly for work on a railway line, having at least one machine-tool such as an abrasive rail saw, and a device for driving the machine. The machine-tool is provided with an electric motor powered by an electric battery which is advantageously arranged in an assembly that can be worn by the operator of the machine and is connected to the motor by a power discharge cable.

### TECHNICAL FIELD

The disclosure relates to a machine-tool system, in particular for work on a railway line, comprising at least one machine-tool such as an abrasive rail saw, and a device for driving the machine.

### BACKGROUND

It is known in the state of the art to use machines equipped with a heat engine mounted on the machine in systems of this type. The systems have the drawback that the machines are heavy and relatively difficult to handle.

### SUMMARY

The disclosure aims to address this drawback.

In order to achieve this aim, the machine-tool system according to the disclosure is characterized in that the machine-tool is equipped with an electric motor powered by an electric battery which is advantageously arranged in a backpack worn by the operator and which is connected to the motor by a power cable.

According to one advantageous feature of the disclosure, the cable is a multicore cable so as to be flexible and to limit the heating of the cable.

According to another feature of the disclosure, each machine-tool includes a specific machine board which identifies the machine and is suitable for dialogue with the battery and is provided with a program for managing the operation of the machine, in cooperation with the battery.

According to still another feature of the disclosure, the battery includes a board for switching the discharge path and the charge path of the battery, a BMS board for controlling the switching board and which is suitable for dialoguing with the machine board connected on the battery.

According to still another feature of the disclosure, the battery is housed in a package provided with an internal device for damping vibrations and impacts.

According to still another feature of the disclosure, the damping device includes a set of flexible shims kept in place by spacers.

According to still another feature of the disclosure, the machine-tool is an abrasive saw for objects, such as rails, including a saw disc able to rotate in both directions of rotation, and mounted pivoting about an axle of a fastening support device on the rail, so as to allow the sawing of an object while being placed on both sides of the object, by reversing about the pivot axle without disassembly of the support device.

According to still another feature of the disclosure, the abrasive saw comprises a bushing for receiving the axle of the support device, the bottom of which is provided with an electrical contact which is intended to be actuated by the axle of the bushing when the abrasive saw is mounted on the support.

According to still another feature of the disclosure, the control handle is provided with a pivoting lever for controlling the abrasive saw.

According to still another feature of the disclosure, the machine includes two safety handles, one of which is located above and the other below the machine mounted on the support device, in a vertical plane, such that the handle which is the lower handle in the rotation position of the disc in one direction, becomes the upper handle when the disc rotates in the opposite direction.

According to still another feature of the disclosure, the abrasive saw is in the operating state when the operator has mounted the abrasive saw on its support and actuated the control lever and the upper safety handle.

According to still another feature of the disclosure, the bushing for receiving the pivot axle on the support is positioned on the axis passing through the center of the disc and a control handle of the machine, located on the end of the machine, opposite the end of the disc side, to ensure the same operating conditions in each direction of rotation of the disc.

According to still another feature of the disclosure, the system comprises a belt transmission device for transmitting the rotation of the drive shaft to the device including the strand located on the side of the axle of the device of the support; this strand is deflected by a pallet.

According to still another feature of the disclosure, the machine is in the operating state when the operator simultaneously actuates a control lever associated with the control handle and the upper safety handle.

### BRIEF DESCRIPTION OF THE DRAWINGS

The disclosure will be better understood, and other aims, features, details and advantages thereof will appear more clearly, during the following explanatory description done in reference to the appended drawings, provided solely as an example illustrating one embodiment of the disclosure and in which:

FIG. 1 is an exploded perspective view of the machine-tool system according to the disclosure, showing a plurality of machine-tools, usable in this system;

FIG. 2 is a perspective view of the machine-tool system according to the disclosure, including, as machine-tool, an abrasive rail saw for a railway line;

FIGS. 3A to 3D are perspective views of the abrasive saw of FIG. 1, showing the latter in four different operating positions;

FIG. 4 is a perspective view of the assembly of the backpack and the battery;

FIG. 5 is an exploded view of the assembly of FIG. 4;

FIG. 6 is a perspective view of the connector platen of the battery;

FIGS. 7A to 7F are perspective views illustrating the various components of the package of the battery;

FIG. 8 is an exploded view showing the battery and the housing package thereof;

FIG. 9 is a sectional view along line IX-IX of FIG. 8, through the package enclosing the battery;

FIGS. 10A and 10B are two views of two faces of a machine board according to the disclosure;

FIG. 11A is a perspective view of an abrasive rail saw according to the disclosure;

FIG. 11B is a larger scale detailed view of an inner part of the abrasive saw casing of FIG. 11A;

FIG. 12 is a sectional view illustrating the device for driving the rotation of the disc of the abrasive saw according to FIG. 11;

FIG. 13 is an enlarged view of part XIII of FIG. 12; and

FIG. 14 is a schematic view illustrating the section of a rail, after reversing an abrasive saw according to the disclosure; and

FIG. 15 is a synoptic view of the operation of the machine-tool system according to the disclosure.

### DETAILED DESCRIPTION OF THE DRAWINGS

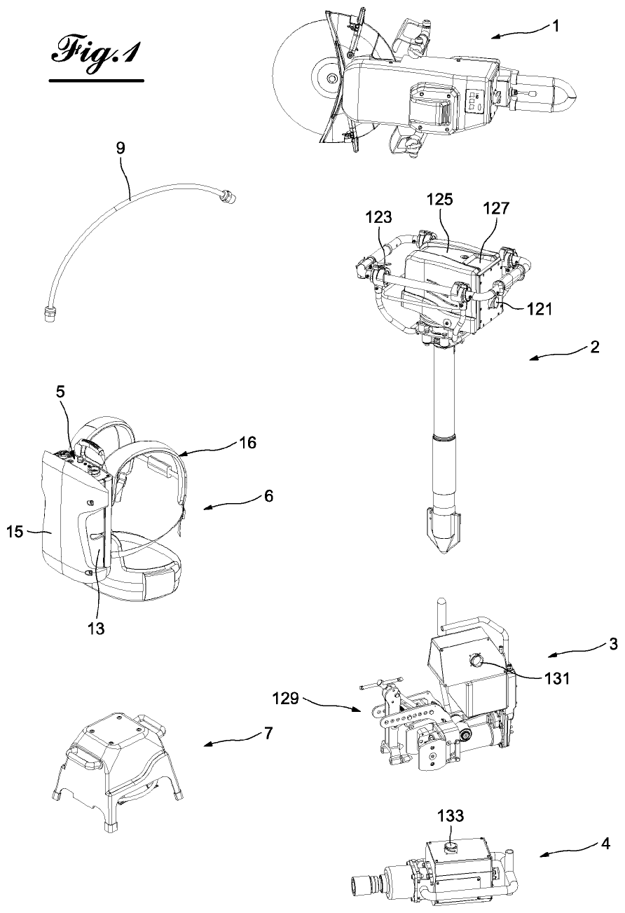

FIG. 1 generally illustrates the machine-tool system according to the disclosure, with a plurality of machine-tools which are usable in the context of this system, namely, in the illustrated example, an abrasive saw 1, in particular but not exclusively for rails of a railway line, a vibrator 2 which makes it possible, for example, to compact the ballast between the ties, a rail drill 3, for example, which is intended to drill holes in the rails in order to fix connecting splice bars or braids, and an impact wrench 4 making it possible to screw or unscrew the fasteners or track bolts. The machines are equipped with an electric motor and are electrically powered by a battery 5 integrated into an assembly 6 which can be worn by the user of a machine, advantageously in the form of a backpack. Each machine is connectable to the battery by a discharge cord or cable 9. The machines being high-power machines for example of the order of 3 to 10 kW, the cord 9, so as not to be bothersome for the user, is a flexible multicore cable including a multitude of electrical conductors with a small cross-section, which allows the cord to be flexible and to limit heating by the electric current circulating between the battery and the electric motor of the machine connected on the battery.

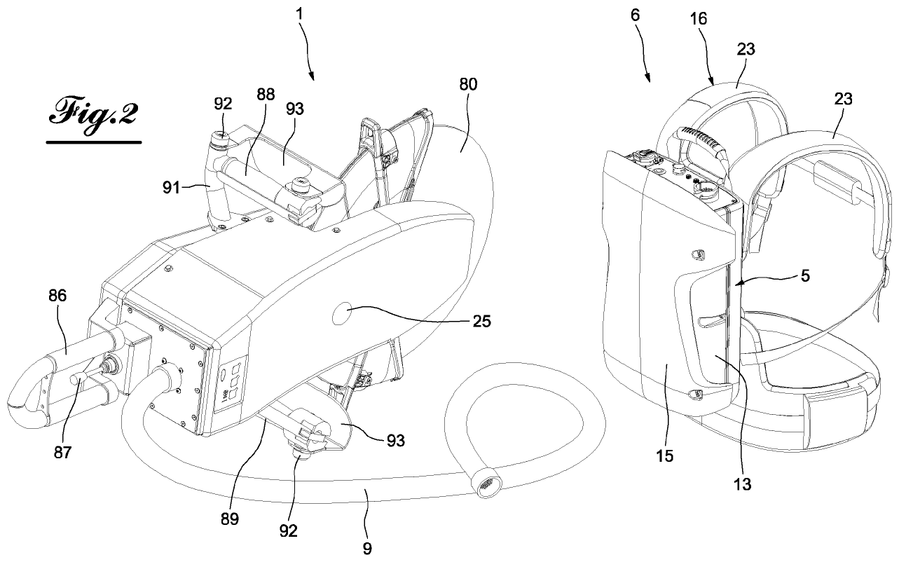

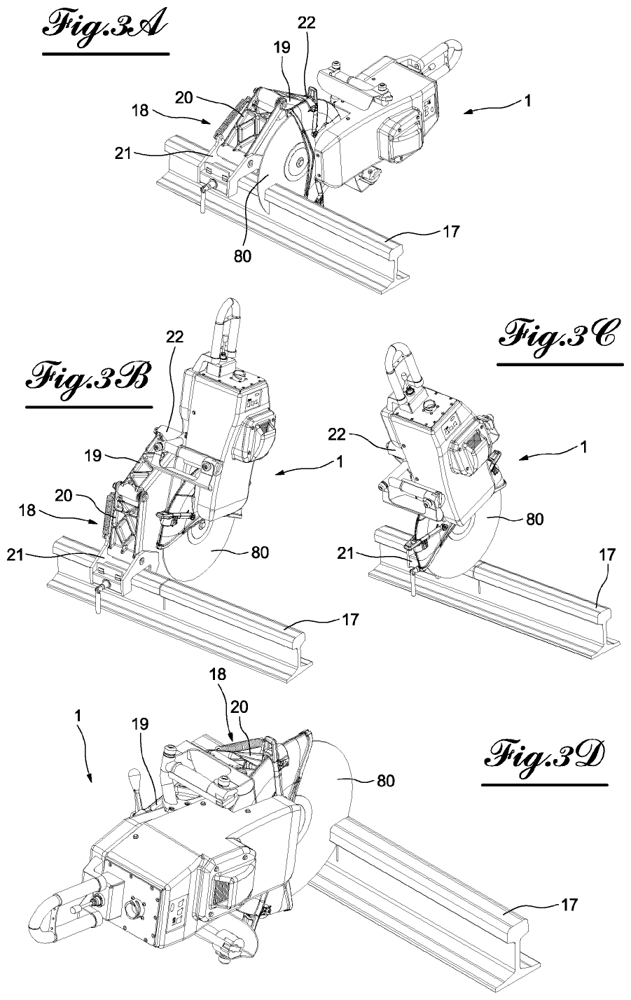

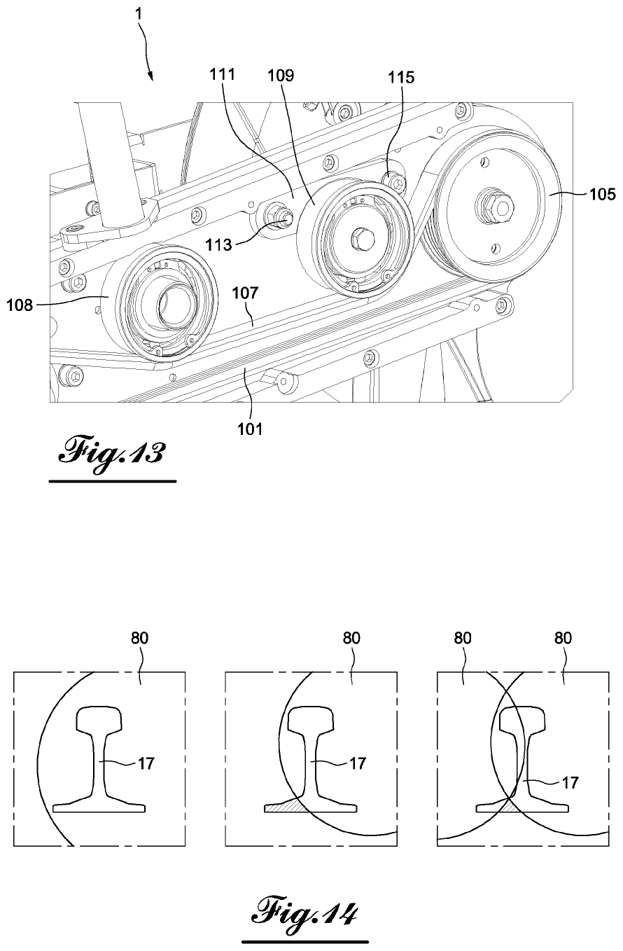

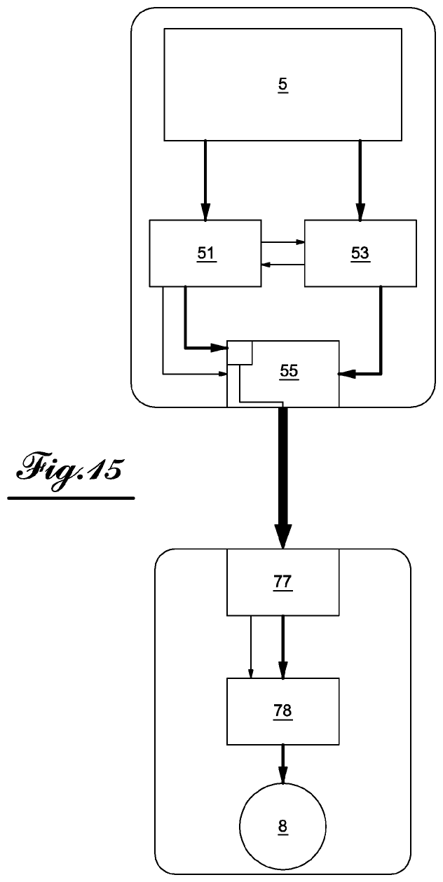

The machine-tool system according to the disclosure will be described hereinafter, by way of non-limiting example in its embodiment including, as machine-tool, an abrasive saw, particularly but not exclusively, rails of a railway line, as shown in 1 in FIGS. 1 and 2, in FIGS. 3A to 3D and in FIGS. 11 to 13.

As shown by the figures, in the machine-tool system according to the disclosure, the abrasive saw 1 is provided with an electric motor indicated by reference 8 in FIGS. 11B and 15, and driven by the electric battery 5 positioned in a package 13 in the form of a shell on which an outer shell 15 is fixed. The assembly formed by the outer shell 15 and the package 5 is completed by an ergonomic carrying device 16 in order to form the assembly 6 of the backpack device which can be worn by an operator of the machine-tool. The carrying assembly makes it possible to eliminate the weight of the battery on the machine. A battery charger 7 allows fast recharging of the battery, for example in 2 hours (FIG. 1).

As shown in FIGS. 3A to 3D, in order to cut a rail 17, the abrasive saw 1 is mounted pivoting on a support and fastening vise device 18 with two articulated arms 19, 20. One of the two arms, namely the arm 20, is provided at its free end with a vise 21 for fastening by clamping on the rail, while the other arm 19 bears, at its free end, an axle 22 on which the abrasive saw is mounted pivotably. To this end, the abrasive saw includes a bushing for receiving the axle, denoted 25 (page 2). At the bottom of the bushing, an electric contact (not shown) is provided which is closed when the machine is correctly placed on the axle 22 of the vise.

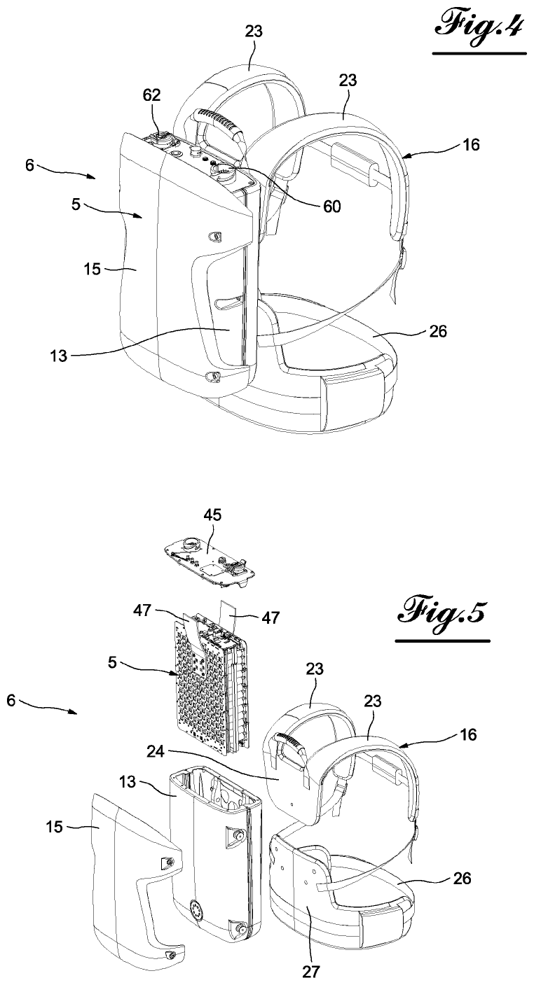

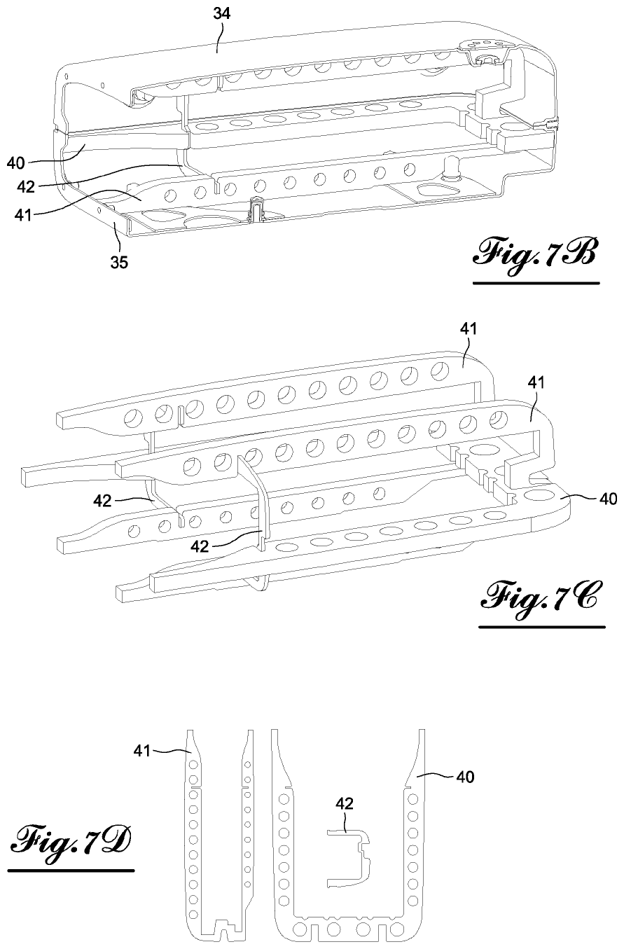

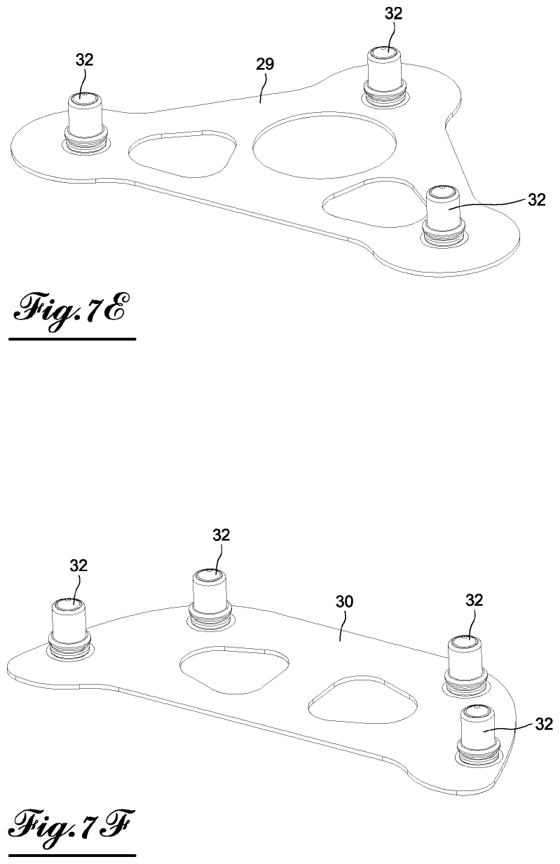

The carrying assembly of the battery and of the latter will be described in more detail hereinafter, in reference to FIGS. 4 to 9. The exploded view of FIG. 5 shows the various components of the assembly, namely the battery 5, the package 13 in shell form, the outer shell 15 and the carrying device 16 essentially including two straps 23, each for one shoulder of the operator, which are mounted on a fastening plate 24 and an adjustable abdominal belt 26, the rear median part 27 of which is wider to allow the belt to be mounted on the package 13. In order to fasten the carrying device 16 on the package/shell 13, the latter is provided with platens 29, 30 (FIGS. 7E, 7F), which are formed by sheets to be glued to the inside of the shell and which support tight and tapped inserts 32 for fastening the carrying device 16 on the package using fastening screws for fastening the parts 24, 27 of the device 16 in the tapped inserts 32. The platens are wide enough to offer a good adhesion surface and a good span length for reacting the forces. The tight inserts 32 are crimped on the sheet before gluing on the shell. The package is designed to constitute the outer protective element of the battery and the outer shell 15 fixed on the shell imparts additional security.

The shell package 13 for exterior protection of the battery is made up of two half-shells 34, 35 made from glass fiber/polyester resin characterized by a high strength and an excellent rigidity/mass ratio. Reference 37 designates a sealing gasket cover inserted between the two half-shells. A set of flexible shims 40 and 41 (FIG. 7C) is positioned on the inner sides of the shell. These shims allow the proper positioning of the battery in the shell and have a damping function. They are kept in place by spacers 42 until the battery is mounted in the shell. FIGS. 7B and 7C show that the shim 40 is located at the junction of the two half-shells, while the two shims 41 are positioned in planes perpendicular to the shim 40 close to the lateral sides of the package.

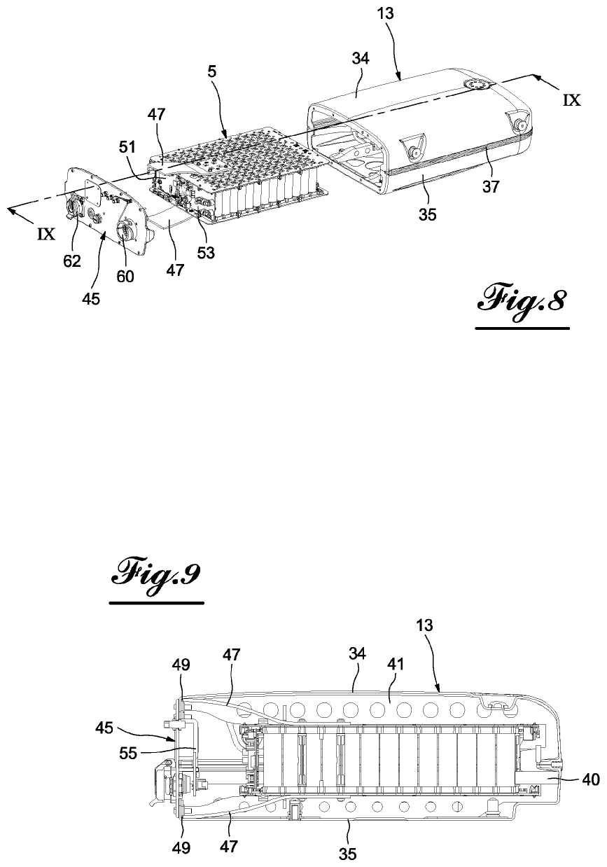

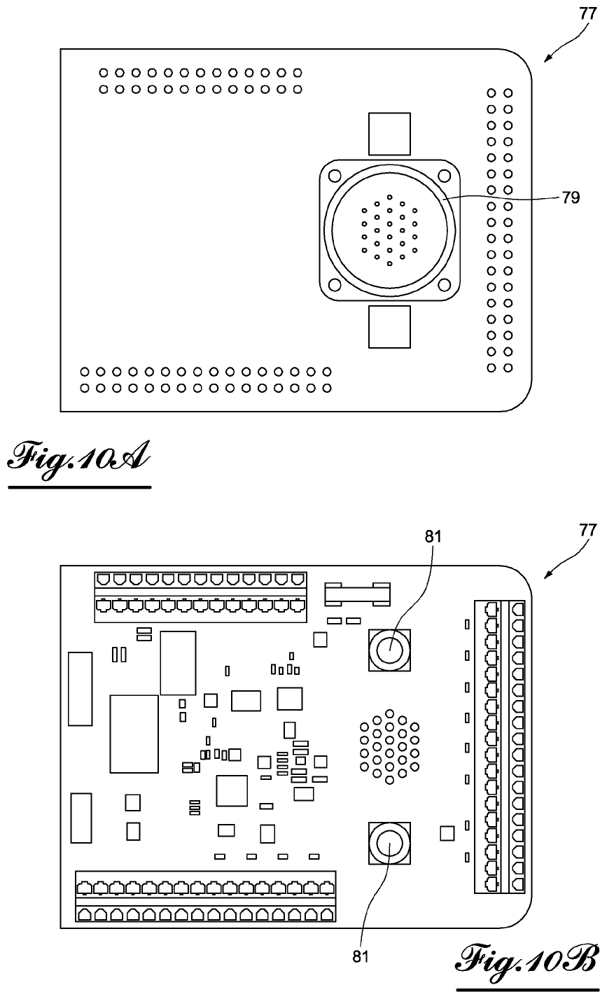

Regarding the battery 5 which is intended to be placed in the package 13, it is equipped with a connector platen 45 (FIGS. 8, 9) located at the opening of the package. It is accommodated by the flexible anti-impact shims 40, 41, which constitute a structure of the foam skeleton type. Two tabs 47 are each fixed on a large side face of the battery, at its end on the opening side. They are intended to eliminate the movement of the battery toward the connector platen while ensuring an absorption of the impacts. To this end, when the battery is placed in the package, the free ends of the flexible tabs 47 engage at 49 behind a stop element at the inlet of the package.

As shown in FIGS. 8 and 9, associated with the battery are a BMS (Battery Management System) board 51, a switching board 53 and a connector board 55, which are placed between the core of the battery and the connector platen 45. The core of the battery, in the illustrated example, is made up of 130 cells of the Li-Ion type. The cells are kept next to one another by two holding elements (not shown) each positioned at one end of the block of cells. Two electronic boards are provided to interconnect the cells and to receive the temperature sensors.

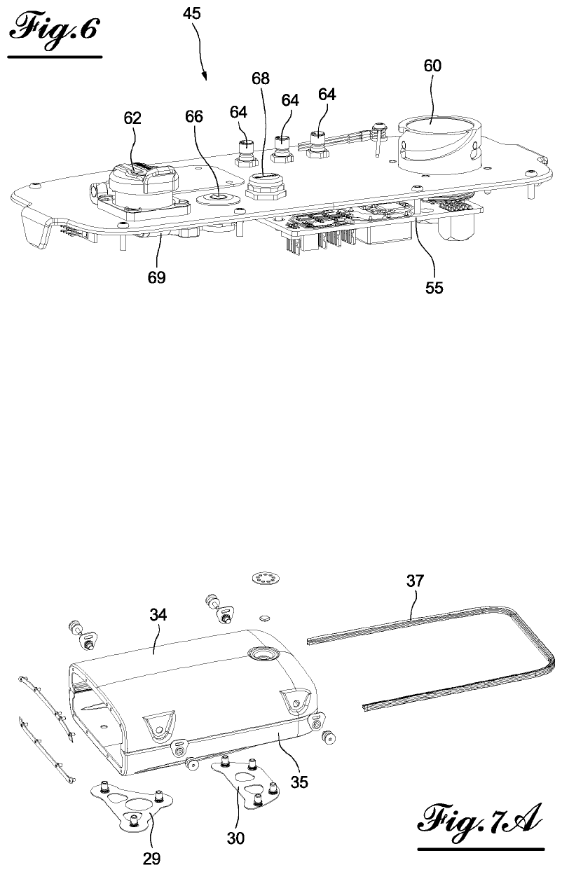

The connector platen 45 (FIGS. 6 and 8) bears, on its outer face, a discharge connector 60 on which the discharge cord is connected which constitutes the power cable, in order to connect the battery to the used machine. This connector is tight, it is equipped with a removable stopper in order to protect it when the cord is not connected. The platen further bears a charge connector 62 in order to connect a charger to the battery, three connectors 64 which make it possible to connect accessories to the battery, such as the man/machine interface MMI, an LED bulb and the USB recharging cord, a start button 66 and an access hatch 68 to a memory card. The charge connector 62 is equipped with an automatic closure lid which makes it possible to protect the electric contact when the charger is not connected. The start button 66 is a lighted button. When it is illuminated, the battery is started. When it is turned off, the battery is stopped. The battery enters “standby” mode 10 minutes after having been turned off (energy saving mode) or after 10 minutes of inactivity. Blinking modes are provided to indicate different types of faults to the user. The platen also bears a breather 69. Regarding the breather 69, since the battery is tight, it makes it possible to balance the pressure between the inside and the outside of the battery by preventing the introduction of any moisture. The memory card contains the operating parameter of the battery as well as information on the machines used.

The connector board 55 bears a 48 V/5 V transformer that allows the powering of the accessories, the powering of the machine board by the initiation of the system, the connector technology for the distribution of the accessory bundles and the ADC BUS, the connector technology for the start connection 66, a “low battery” alarm buzzer indicating to the user that it is necessary to recharge the battery so as not to damage the cells, the power connection pads of the battery and a multi-pin discharge connector. At the outlet of the battery 5, there are two power cables of large section which are not flexible. The multi-pin connector serves to distribute the high power over a plurality of pins which are compatible with the plurality of conductors of smaller section of the discharge cord or cable, which is designed to be as flexible as possible in order to facilitate the use of the machines and to limit the heating of the cord. More specifically, in one advantageous example embodiment of the multi-pin connector, the latter includes twenty-four pins, namely ten pins for the +48 V, ten pins for the 0 V, one+5 V pin, one 0 V pin, one pin for the high ADC and one pin for the low ADC. The discharge cable includes a conductor for each pin. The connector board further includes a relay which protects the charge path, which serves to prevent the presence of current on the charge path, when no connector is connected thereon. A circuit is provided in the cabling of the charge connector which allows the closing of the charge circuit when it is connected on the battery.

The BMS board 51 provides safety functions, in particular protection against overloads, protection against short-circuits and monitoring of the temperature. It also ensures management of the cells, namely monitoring of the discharge and charge of the cells. Then the board performs communication functions, that is to say controlling the switching board, managing the memory card, the buzzer and the man/machine interface MMI and, if applicable, links with other applications.

The switching board 53 includes an electronic relay which is controlled by the BMS board 51 and serves to perform the function of cutting off the power on the discharge path of the battery, managing the charge path, managing the pre-charge circuit of the motor controllers of the machines, and protecting against overloads and short-circuits.

After describing the part of the system located on the side of the battery, the different components thereof and their functions, the part of the system located on the side of the machine-tools will be described hereinafter.

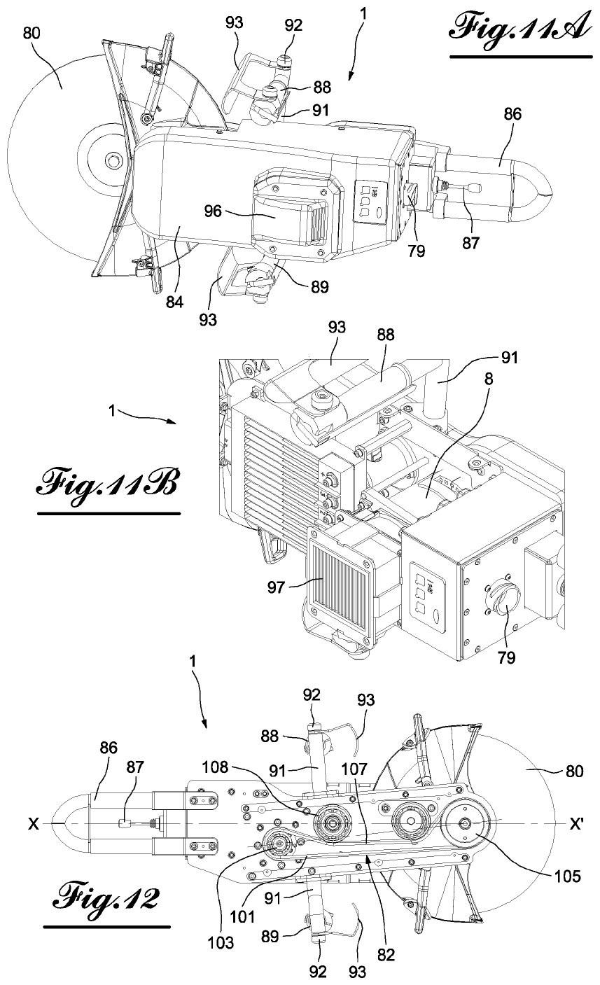

This machine which will be connected on the battery 5 is equipped with a machine board 77, the two faces of which are shown in FIGS. 10A and 10B, and which bears a multi-pin connector 79 allowing the connection of the discharge cord, and two power pads 81 which respectively connect the ten+48 V pins and the ten 0 V pins, in order to provide electrical power to the motor controller. The board also includes the connection terminals for the inputs/outputs and is suitable for managing the logic inputs/outputs. The board also serves to establish a dialogue with the battery in order to identify the machine during the connection and to send commands to the motor controller 78 in order to control the motor.

Each machine board has a program which manages the specific operation of the machine according to the following operating logic: the discharge cord is connected on the machine board, the permanent voltage 0/5 V makes it possible to start the machine board, an encrypted dialogue on the ADC BUS begins between the machine board and the BMS board 51. If the machine board is recognized, the BMS board authorizes the closing of the 48 V discharge path. The switching board 53 manages the pre-charging of the motor controller 78. The machine is ready to be used if the start conditions are met.

Regarding the machine-tools which can be used in the context of the system according to the disclosure, hereinafter, the abrasive saw 1 will be described in more detail as shown in FIGS. 1, 3A to 3D and 11 to 13. This abrasive saw includes a saw disc 80 which is rotated, by means of a transmission device 82, by an electric motor 8 contained in a casing 84. The abrasive saw is provided at its end opposite that of the disc with a control handle 86 provided with a pivoting lever 87 for controlling the motor so that the latter rotates the disc in one direction of rotation or the other by pivoting the lever upward or downward. The abrasive saw further includes a pair of safety handles, namely an upper handle 88 and a lower handle 89. It should be noted that, in order to start the disc after having mounted the machine on the support vise 18 by slipping the machine, owing to its bushing 25, on the axle 22, which causes the closing of the electrical contact at the bottom of the bushing, the operator must actuate both the control lever 87 by causing it to pivot upward and the upper safety handle 88 or 89 in order to actuate a contact integrated into this handle. If this sequence of operations is not done in the described order, the machine will not work. As shown in the figures, each handle is located either above or below the casing, at a certain distance from the upper or lower surface thereof, and is carried by a rod 91 which extends in a plane parallel to the plane of the disc, while protruding above and below the casing and ends with an end in the form of a foot 92. Each handle 88, 89 extends perpendicular to its support rod and to the plane of the disc, near the foot of the rod. Each handle has an associated guard 93. On the end side face on which the control handle 86 is located, the multi-pin connector 79 can be seen for connecting the discharge cord. On a lateral side of the casing, a cover 96 is fixed which covers an air filter 97 through which, by an internal electric fan, a stream of air is suctioned for cooling the motor, which passes through the motor and is discharged to the front on the disc side. The suction opening is on the operator side. The air filter makes it possible to prevent metallic particles produced by the sawing of the rail or abrasive particles coming from the wear of the disc from being able to be introduced into the motor. On the other lateral side of the chassis, the bushing 25 is provided for receiving the support axle of the vise.

In order for the operator not to begin cutting without being sure that he will be able to finish it, an LED display is provided on the casing, which provides the operator with information on the quantity of remaining energy available in the battery, relative to the quantity of energy necessary to perform a complete cut, following an analysis done by the machine board, which illuminates the LEDs based on the result. An LED which is for example green indicates that the cutting can be started and that there is enough energy to finish it. Illuminating an LED which is for example yellow indicates that a final complete cut is still possible. Conversely, when there is a red LED, the operator should not begin a cut, as there is not enough energy in the battery to finish it. The display also includes a “dirty filter” LED, which indicates to the operator that he has reached a number of cuts which requires replacing the air filter.

One very advantageous particularity of the abrasive saw according to the disclosure lies in the fact that it makes it possible to perform a cut of a rail by reversal, without the operator being required to disassemble the machine from the axle of the vice, as illustrated by FIGS. 3A to 3D.

FIG. 3A shows the abrasive saw, mounted on the axle of the support vise, with the two articulated arms 19, 20. As indicated above, the operator has begun the cut by actuating the safety handle 88 and the rotation control lever 87 when he grips the handle 86. If the cut is not possible in a single operation, the operator removes the disc from the beginning of the cut, stops the rotation of the disc by releasing the control lever and reverses the machine without disassembly from the vise axle 22, by taking it from the position of FIG. 3B, on one side of the rail, to the position according to FIG. 3C on the other side of the rail. To continue the cut, the operator actuates the other safety handle 89, which is now the upper handle, and the control lever 87, which he pivots in the opposite direction relative to the first phase such that the disc can now rotate in the opposite direction.

So as to be able to perform a cut by reversal without disassembly of the abrasive saw from the vise, the bushing for receiving the vise screw is placed in the axle which passes through the center of the disc 80 and the control handle 86, 87 and is indicated by references X, X′, so as to be symmetrical in terms of the kinematics of the set of levers made up of the vise arms in order to ensure the same operating conditions in both directions of rotation of the disc. FIG. 12 shows the particular configuration of the components of the device for transmitting the relative movement from the motor axle to the axle of the disc. This transmission is done using an endless transmission belt 101, which transmits the rotational movement of a roller 103 secured in rotation with the axle of the motor to a roller 105 secured in rotation with the disc. In order to prevent one of the strands of the belt 101, namely the strand 107, from passing over the axle of the vise screw, this strand is deflected by a roller 108.

The belt 101 is advantageously an elastic belt, striated lengthwise, which does not require tension adjustment, or upkeep. In order to prevent the placement of the belt from having to be done using a specific mounting tool, the disclosure provides for the use of a roller 109, which is supported by a lever 111 mounted pivoting about an axle 113 and able to be fixed in position by a screw 115.

FIG. 14 illustrates the various cutting modes of a rail. The image on the left shows the type of cutting comprising cutting the entire rail without having to reverse the machine. To perform this type of cutting, the machine must be equipped with a new disc. The other two images illustrate cutting in two phases when the wear of the disc has reached a certain degree and its diameter has decreased such that a complete cut is no longer possible. In this case, according to the image in the middle, the operator, working from a first side, first cuts the entire head and core of the rail, as well as part of the flange, the crosshatched part remaining uncut. After having set the motor at idle speed and waited for the disc to stop completely, the operator removes the disc from the beginning of the cut and pivots the machine to the other side of the rail by 180°, restarts the abrasive saw and finishes cutting the rail, as shown in the image on the right.

In the preceding, the disclosure has been described in its embodiment using an abrasive rail saw. Of course, this abrasive saw can be used by connecting it to any other appropriate power source, portable or even stationary.

As shown in FIG. 1, the system according to the disclosure can be used with other machine-tools such as a vibrator mounted at the top of FIG. 1 and denoted 2, a rail drill 3 shown in the middle and the impact wrench 4 shown at the bottom.

Regarding the vibrator 2, the discharge cable of the battery connects on the connector indicated by reference 121. The starting and stopping of the vibrator are done by actuating or releasing the handle 123. The electric motor is cooled by a stream of air generated by an electric fan and which passes through the motor. To prevent particles of dust raised by the packing work from being able to reach the motor, an air filter 125 is provided whose removable cover has been removed in the figure. The motor, filtration and electrical box assembly is covered by a plastic cover, not shown. An LED screen 127 is present in order to indicate the approximate duration of work remaining.

Regarding the rail drill 3, which is provided with a device 129 for fastening on the rail, the discharge cable of the battery is connected on the connector indicated at 131.

Regarding the impact wrench 4, its multi-pin connector for connecting to the discharge cable is indicated at 133.

As already stated above, each machine-tool is equipped with its own machine board 77 specific to it. Once a machine-tool is connected to the battery, by means of a discharge cord, the machine board of the connected machine establishes a dialogue with the BMS board, by means of the ADC BUS in order to allow the identification of the machine owing to an identification code which the machine board sends to the BMS board. When the machine board is identified, the BMS board which serves to control the switching board authorizes the closing of the discharge path going from the battery, through the switching board, the connector board, the multicore cable, the machine board and the motor controller to the motor. The specific operation of each machine is managed by the machine board which has the operating program and therefore sends commands to the motor controller for the control thereof. The machine is then ready to be used if the start conditions are met, that is to say, if the operator has actuated the control members, in the case of the abrasive saw, the control handle and the safety lever corresponding to the desired direction of rotation of the saw disc.

1. A machine-tool system comprising: at least one machine-tool such as an abrasive rail saw, and a device for driving a machine, wherein the machine-tool is equipped with an electric motor powered by an electric battery advantageously positioned in an assembly configured to be worn by an operator of the machine and is connected to the motor by a power discharge cable.

2. The system according to claim 1, wherein the cable is a multicore cable configured to be flexible and to limit heating of the cable.

3. The system according to claim 1, wherein each machine-tool includes a specific machine board which identifies the machine and is suitable for dialogue with the battery and is provided with a program for managing operation of the machine, in cooperation with the battery.

4. The system according to claim 1, wherein the battery includes a board for switching the discharge path and the charge path of the battery, a BMS board for controlling the switching board and which is suitable for dialoguing with the machine board connected on the battery.

5. The system according to claim 1, wherein the battery is housed in a package provided with an internal device for damping vibrations and impacts.

6. The system according to claim 5, wherein the damping device includes a set of flexible shims kept in place by spacers.

7. The system according to claim 1, wherein the machine-tool is an abrasive saw for objects, such as rails, including a saw disc able to rotate in both directions of rotation, and mounted pivoting about an axle of a fastening support device on the rail, so as to allow the sawing of an object while being placed on both sides of the object, by reversing about the pivot axle without disassembly of the support device.

8. The system according to claim 7, wherein the abrasive saw comprises a bushing for receiving the axle of the support device, the bottom of which is provided with an electrical contact intended to be actuated by the axle of the bushing when the abrasive saw is mounted on the support.

9. The system according to claim 8, wherein the control handle is provided with a pivoting lever configured for controlling the abrasive saw.

10. The system according to claim 9, wherein the machine includes two safety handles, one of the safety handles is located above and the other of the safety handles is located below the machine mounted on the support device, in a vertical plane, such that the handle which is the lower handle in the rotation position of the disc in one direction, becomes the upper handle when the disc rotates in the opposite direction.

11. The system according to claim 10, wherein the abrasive saw is in the operating state when the operator has mounted the abrasive saw on its support and actuated the control lever and the upper safety handle.

12. The system according to claim 8, wherein the bushing for receiving the pivot axle on the support is positioned on the axis X, X′ passing through the center of the disc and a control handle of the machine, located on the end of the machine, opposite the end of the disc side, to ensure the same operating conditions in each direction of rotation of the disc.

13. The system according to claim 12, further comprising a belt transmission device configured for transmitting the rotation of the drive shaft to the device including the strand located on the side of the axle of the device of the support, wherein the strand is deflected by a pallet.

14. The system according to claim 8, wherein the machine is in the operating state when the operator simultaneously actuates a control lever associated with the control handle and the upper safety handle.
